(19) United States
(12) Patent Application Publication
(10) Pub. No.: US 2009/0124727 A1
(43) Pub. Date: May 14, 2009

(54) NANOPARTICLE-MODIFIED POLYISOCYANATES

(75) Inventors: Arno Nennemann, Bergisch-Gladbach (DE); Markus Mechtel, Bergisch-Gladbach (DE); Thomas Klimmasch, Leverkusen (DE); Christopher Guertler, Koeln (DE); Michael Mager, Leverkusen (DE); Meike Niesten, Koeln (DE); Robert Maleika, Duesseldorf (DE)

Correspondence Address: CONNOLLY BOVE LODGE & HUTZ, LLP, P O BOX 2207, WILMINGTON, DE, 19899, US

(73) Assignee: Bayer MaterialScience AG, Leverkusen (DE)

(21) Appl. No.: 12/267,851

(22) Filed: Nov. 10, 2008

(30) Foreign Application Priority Data
Nov. 8, 2007 (EP) 07021690.8

(51) Int. Cl. C08K 7/00

(52) U.S. Cl. 523/206

(57) ABSTRACT

The present invention relates to nanoparticle-modified polyisocyanates which have been modified by a special siloxane unit and consequently have improved performance properties and also storage stabilities.

### RELATED APPLICATIONS

This application claims benefit to European Patent Application No. 07021690.8, filed Nov. 8, 2007, which is incorporated herein by reference in its entirety for all useful purposes.

### BACKGROUND OF THE INVENTION

The present invention relates to nanoparticle-modified polyisocyanates which have been modified by a special siloxane unit and consequently have improved performance properties and also storage stabilities.

U.S. Pat. No. 6,593,417 discloses coating compositions which are based on a polyol component which besides the nanoparticles also contains polysiloxanes. The extent to which these polysiloxanes are suitable for modifying polyisocyanates is not described.

EP-A 1 690 902 describes surface-modified nanoparticles with polysiloxane units attached covalently to their surfaces. Not described are polysiloxane-modified binders containing nanoparticles.

A series of patents describe surface-functionalized particles having groups that are potentially reactive towards the film-forming resins, and their use in coatings (EP-A 0 872 500, WO 2006/018144, DE-A 10 2005 034348, DE-A 199 33 098, DE 102 47 359). The systems in question include nanoparticles which carry blocked isocyanate groups, and dispersions thereof which are used in a blend with binders.

EP-A 0 872 500 and WO 2006/018144 disclose, for example, colloidal metal oxides whose nanoparticle surfaces have been modified via covalent attachment of alkoxysilanes. The alkoxysilanes used for the modification are addition products of aminoalkoxysilanes and blocked, monomeric isocyanates. Metal oxides modified in this way are then mixed with the binders and curing agents and used as an isocyanate component for the production of coating materials. Essential to the invention here is the presence of water and alcohol in the preparation process for the hydrolysis of the alkoxy groups, with subsequent condensation on the particle surfaces, producing a covalent attachment. Likewise essential to the invention is a blocking of free NCO groups in order to prevent reaction with water and alcoholic solvent. The systems in question here, therefore, are modified nanoparticles, and not nanoparticle-containing polyisocyanates. On reaction, accordingly, the nanoparticles are incorporated covalently into the film-forming matrix and hence dominate the film-forming matrix, which from experience can lead to detractions in terms of the flexibility. It is disadvantageous, moreover, that, owing to this process, which necessitates the use of water and alcoholic solvent, it is not possible to use non-blocked polyisocyanates. Not described is the use of polysiloxane units.

WO 2007/025670 and WO 2007/025671 disclose hydroxyl-functional polydimethylsiloxanes as part of a polyol component of polyurethane coating materials. The extent to which such hydroxyl-functional polydimethylsiloxanes are then suitable for modifying polyisocyanates is not addressed.

German Application No. 10 2006 054289, unpublished at the priority date of the present specification, discloses nanoparticle-containing polyisocyanates which are obtained by modifying polyisocyanates with aminoalkoxysilanes and adding nanoparticles.

It has now surprisingly been found that nanoparticle-containing polyisocyanates of this kind can be modified advantageously by hydroxyl-functional polydimethylsiloxanes, thereby making it possible to achieve a significant improvement in the performance properties of coating compositions prepared from them.

### EMBODIMENTS OF THE INVENTION

An embodiment of the present invention is a process for preparing a nanoparticle-modified polyisocyanate, comprising reacting
A) a polyisocyanate with
B) an alkoxysilane of formula (I)

Q-Z-SiXₐY₃₋ₐ (I)
wherein
Q is an isocyanate-reactive group,
X is a hydrolysable group,
Y is identical or different alkyl groups,
Z is a C₁-C₁₂ alkylene group, and
a is an integer from 1 to 3;
C) a hydroxyl-containing polysiloxane of formula (II) and having an number-average molecular weight in the range of from 200 to 3000 g/mol and an average OH functionality of greater than or equal to 1.8:

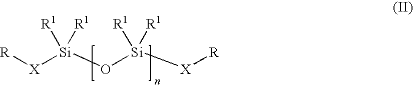

wherein
   X is an aliphatic, optionally branched C1 to C10 radical; or
      a —[OCH₂CHZ]ₙO— unit, wherein Z is H or methyl, and n is an integer from 1 to 12; or
      a —CH₂O(CH₂)ᵣ— unit, wherein r is an integer from 1 to 4;
   R is a hydroxyfunctional carbon acid ester unit of formula

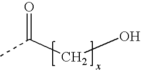

wherein x is an integer from 3 to 5; or
a CH(OH)Y group, wherein
Y is a —CH2—N(R2R3) group, wherein
R2 is H or a methyl ethyl, n-propyl, iso-propyl, cyclohexyl, 2-hydroxyethyl, 2-hydroxypropyl or 3-hydroxypropyl radical; and
R3 is a 2-hydroxyethyl, 2-hydroxypropyl, or 3-hydroxypropyl radical;
R1 is, identically or differently, H or a C1 to C10 hydrocarbon radical optionally containing hetero atoms; and
n is an integer from 1 to 40; and
D) optionally, blocking agents;
to form a dispersion; and incorporating optionally surface-modified inorganic particles having an average particle size of less than 200 nm, as determined by means of dynamic light scattering in dispersion, into said dispersion.

Another embodiment of the present invention is the above process, wherein said polyisocyanate comprises a uretdione, isocyanurate, allophanate, biuret, iminooxadiazinedione, and/or oxadiazinetrione structure.

Another embodiment of the present invention is the above process, wherein said polyisocyanate is based on IPDI, MDI, TDI, HDI, or mixtures thereof.

Another embodiment of the present invention is the above process, wherein, in formula (I), X is an alkoxy or hydroxyl group, Y is a linear or branched C₁-C₄ alkyl group, Z is a linear or branched C₁-C₄ alkylene group, a is 1 or 2, and Q is a group which reacts with isocyanates to form urethane, urea, or thiourea moieties.

Another embodiment of the present invention is the above process, wherein said alkoxysilane of formula (I) is an alkoxysilyl-containing aspartic ester.

Another embodiment of the present invention is the above process, wherein X in formula (II) is —CH₂—, —CH₂CH₂—, —CH₂CH₂CH₂—, —CH(CH₃)CH₂—, —CH₂CH₂CH₂CH₂—, —CH₂CH₂CH(CH₃)—, or —CH₂CH(CH₃)CH₂—, wherein Z is H and n is an integer from 1 to 5 in said —[OCH₂CHZ]ₙO— unit, wherein r is 3 in said —CH₂O(CH₂)ᵣ— unit, and wherein x is 5.

Another embodiment of the present invention is the above process, wherein X in formula (II) is —CH₂—.

Another embodiment of the present invention is the above process, wherein said hydroxyl-containing polydimethylsiloxane of formula (II) has a number-average molecular weight of 250 to 2250 g/mol.

Another embodiment of the present invention is the above process, wherein the ratio of NCO groups of said polyisocyanate to the NCO-reactive OH groups of said hydroxyl-containing polysiloxane of formula (II) is in the range of from 1:0.001 to 1:0.4 and the ratio of NCO groups of said polyisocyanate to the NCO-reactive groups Q of said alkoxysilane of formula (I) is in the range of from 1:0.01 to 1:0.75.

Another embodiment of the present invention is the above process, wherein blocking agents are used in said process in amount that results in the blocking of any remaining free isocyanate groups.

Another embodiment of the present invention is the above process, wherein said inorganic particles having an average particle size of less than 200 nm comprise are incorporated in the form of a dispersion in an organic solvent.

Another embodiment of the present invention is the above process, wherein said organicsolvent is alcohol-free and ketone-free.

Another embodiment of the present invention is the above process, wherein said inorganic particles having an average particle size of less than 200 nm comprise silicon oxide, aluminium oxide, cerium oxide, zirconium oxide, niobium oxide, titanium oxide, or zinc oxide.

Another embodiment of the present invention is the above process, wherein said inorganic particles having an average particle size of less than 200 nm are surface-modified.

Yet another embodiment of present invention is a nanoparticle-modified polyisocyanate obtained by the above process.

Yet another embodiment of present invention is a polyurethane system comprising the above nanoparticle-modified polyisocyanate.

Yet another embodiment of present invention is a coating, adhesive bond, or moulding comprising the above polyurethane system.

### DESCRIPTION OF THE INVENTION

The present invention accordingly provides a process for preparing nanoparticle-modified polyisocyanates, comprising reacting
A) polyisocyanates; with
B) alkoxysilanes of the formula (I)

Q-Z-SiXₐY₃₋ₐ (I)
wherein
Q is an isocyanate-reactive group,
X is a hydrolysable group,
Y is identical or different alkyl groups,
Z is a C₁-C₁₂ alkylene group, and
a is an integer from 1 to 3;
C) hydroxyl-containing polysiloxanes having number-average molecular weights of 200 to 3000 g/mol and an average OH functionality of greater than or equal to 1.8 of formula (II)

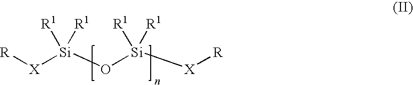

wherein
   X is an aliphatic, optionally branched C1 to C10 radical preferably —CH₂—, —CH₂CH₂—, —CH₂CH₂CH₂—,
      —CH(CH₃)CH₂—, —CH₂CH₂CH₂CH₂—, —CH₂CH₂CH(CH₃)— or —CH₂CH(CH₃)CH₂—, particularly preferably —CH₂—; or
      a —[OCH₂CHZ]ₙO— unit, wherein Z is H or methyl, preferably H, and n is an integer from 1 to 12, preferably from 1 to 5; or more preferably
      a —CH₂O(CH₂)ᵣ— unit, wherein r is an integer from 1 to 4, preferably 3;
   R is a hydroxyfunctional carbon acid ester unit of formula

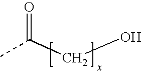

wherein x is an integer from 3 to 5, preferably 5;
R is more preferably a CH(OH)Y group, wherein
Y is a —CH2—N(R2R3) group, wherein
R2 is H, or a methyl ethyl, n-propyl, iso-propyl cyclohexyl, 2-hydroxyethyl, 2-hydroxypropyl, or 3-hydroxypropyl radical; and
R3 is a 2-hydroxyethyl, 2-hydroxypropyl, or 3-hydroxypropyl radical;
R1 is, identically or differently, H or a C1 to C10 hydrocarbon radical optionally containing hetero atoms; and
n is an integer from 1 to 40;
D) optionally, blocking agents; to form a dispersion and subsequently incorporating inorganic particles having an average particle size as determined by means of dynamic light scattering in dispersion (Z-average) of smaller than 200 nm, which may have been surface-modified into said dispersion.

It is essential that the process of the invention be carried out anhydrously, in other words that no water be added separately, for example as a component in the process or as a solvent or dispersion medium. Preferably, therefore, the fraction of water in the process of the invention is preferably less than 0.5% by weight, more preferably less than 0.1% by weight, based on the total amount of components A) to E) employed.

In A) it is possible in principle to use all of the NCO-functional compounds having more than one NCO group per molecule that are known per se to the skilled person. These compounds preferably have NCO functionalities of 2.3 to 4.5, NCO group contents of 11.0% to 24.0% by weight, and monomeric diisocyanate contents of preferably less than 1% by weight, more preferably less than 0.5% by weight.

Polyisocyanates of this kind are obtainable by modification of simple aliphatic, cycloaliphatic, araliphatic and/or aromatic diisocyanates and may contain uretdione, isocyanurate, allophanate, biuret, iminooxadiazinedione and/or oxadiazinetrione structures. Additionally it is possible to use such polyisocyanates as NCO-containing prepolymers. Polyisocyanates of this kind are described in, for example, Laas et al. (1994), J. prakt. Chem. 336, 185-200 or in Bock (1999), Polyurethane für Lacke und Beschichtungen, Vincentz Verlag, Hannover, pp. 21-27.

Suitable diisocyanates for preparing such polyisocyanates are any desired diisocyanates of the molecular weight range 140 to 400 g/mol that are obtainable by phosgenation or by phosgene-free methods, as for example by thermal urethane cleavage, and have aliphatically, cycloaliphatically, araliphatically and/or aromatically attached isocyanate groups, such as 1,4-diisocyanatobutane, 1,6-diisocyanatohexane (HDI), 2-methyl-1,5-diisocyanatopentane, 1,5-diisocyanato-2,2-dimethylpentane, 2,2,4- and/or 2,4,4-trimethyl-1,6-diisocyanatohexane, 1,10-diisocyanatodecane, 1,3- and 1,4-diisocyanatocyclohexane, 1,3- and 1,4-bis(isocyanatomethyl)cyclohexane, 1-isocyanato-3,3,5-trimethyl-5-isocyanatomethylcyclohexane (isophorone diisocyanate, IPDI), 4,4′-diisocyanatodicyclohexylmethane, 1-isocyanato-1-methyl-4(3)isocyanatomethylcyclohexane, bis(isocyanatomethyl)norbornane, 1,3- and 1,4-bis(1-isocyanato-1-methylethyl)benzene (TMXDI), 2,4- and 2,6-diisocyanatotoluene (TDI), 2,4′- and 4,4′-diisocyanatodiphenylmethane (MDI), 1,5-diisocyanatonaphthalene or any desired mixtures of such diisocyanates.

It is preferred in A) to use polyisocyanates of the aforementioned kind based on IPDI, MDI, TDI, HDI or mixtures thereof, preferably HDI, IPDI.

Preferably in formula (I) the group X is an alkoxy or hydroxyl group, more preferably methoxy, ethoxy, propoxy or butoxy.

Preferably Y in formula (I) stands for a linear or branched C₁-C₄ alkyl group, preferably methyl or ethyl.

Z in formula (I) is preferably a linear or branched C₁-C₄ alkylene group.

Preferably a in formula (I) stands for 1 or 2.

Preferably in formula (I) the group Q is a group which is reactive towards isocyanates with formation of urethane, urea or thiourea. These are preferably OH, SH or primary or secondary amino groups.

Preferred amino groups conform to the formula —NHR¹, where R¹ is hydrogen, a C₁-C₁₂ alkyl group or a C₆-C₂₀ aryl group or an aspartic ester radical of the formula R²OOC—CH₂—CH(COOR³)—, where R² and R³ are preferably identical or different alkyl radicals, which where appropriate may also be branched, having 1 to 22 carbon atoms, preferably 1 to 4 carbon atoms. With particular preference R² and R³ are each methyl or ethyl radicals.

Such alkoxysilane-functional aspartic esters are obtainable, as described in U.S. Pat. No. 5,364,955, in conventional manner by addition reaction of amino-functional alkoxysilanes with maleic or fumaric esters.

Amino-functional alkoxysilanes of the kind that can be used as compounds of the formula (I) or for preparing the alkoxysilyl-functional aspartic esters are, for example, 2-aminoethyldimethylmethoxysilane, 3-aminopropyltrimethoxysilane, 3-aminopropyltriethoxysilane, 3-aminopropylmethyldimethoxysilane, aminopropylmethyldiethoxysilane.

As aminoalkoxysilanes with secondary amino groups of the formula (I) in B) it is additionally possible also N-methyl-3-aminopropyltrimethoxysilane, N-methyl-3-aminopropyltriethoxysilane, N-phenyl-3-aminopropyltrimethoxysilane, bis(gammatrimethoxysilylpropyl)amine, N-butyl-3-aminopropyltrimethoxysilane, N-butyl-3-aminopropyltriethoxysilane, N-ethyl-3-aminoisobutyltrimethoxysilane, N-ethyl-3-aminoisobutyltriethoxysilane or N-ethyl-3-aminoisobutylmethyldimethoxysilane, N-ethyl-3-aminoisobutylmethyldiethoxysilane and also the analogous C₂-C₄ alkoxysilanes.

Suitable maleic or fumaric esters for preparing the aspartic esters are dimethyl maleate, diethyl maleate, di-n-butyl maleate and also the corresponding fumaric esters. Dimethyl maleate and diethyl maleate are particularly preferred.

A preferred aminosilane for preparing the aspartic esters is 3-aminopropyltrimethoxysilane or 3-aminopropyltriethoxysilane.

The reaction of the maleic and/or fumaric esters with the aminoalkylalkoxysilanes takes place within a temperature range from 0 to 100° C., the proportions being generally chosen such that the starting compounds are used in a molar ratio of 1:1. The reaction may be carried out in bulk or else in the presence of solvents such as dioxane for example. The accompanying use of solvents is less preferred, though. It will be appreciated that mixtures of different 3-aminoalkylalkoxysilanes can also be reacted with mixtures of fumaric and/or maleic esters.

Preferred alkoxysilanes for modifying the polyisocyanates are secondary aminosilanes, of the type described above, more preferably aspartic esters of the type described above, and also di- and/or monoalkoxysilanes.

The aforementioned alkoxysilanes can be used individually or else in mixtures for the modification.

In the modification the ratio between free NCO groups of the isocyanate to be modified and the NCO-reactive groups Q of the alkoxysilane of the formula (I) is preferably 1:0.01 to 1:0.75, more preferably 1:0.02 to 1:0.4, very preferably 1:0.05 to 1:0.3.

In principle it is of course also possible to modify higher fractions of NCO groups with the aforementioned alkoxysilanes, although care must be taken to ensure that the number of free NCO groups available for crosslinking is still sufficient for satisfactory crosslinking.

The reaction of aminosilane and polyisocyanate takes place at 0 to 100° C., preferably at 0 to 50° C., more preferably at 15 to 40° C. Where appropriate, an exothermic reaction may be controlled by cooling.

The polyorganosiloxanes C) of the general formula (II) containing hydroxyl groups preferably have number-average molecular weights of from 250 to 2,250 g/mol, particularly preferably from 350 to 1,500 g/mol.

The polyorganosiloxanes C) of the general formula (E) containing hydroxyl groups are obtainable by reacting corresponding epoxy-functional polyorganosiloxanes with hydroxyalkyl-functional amines, preferably in a stoichiometric ratio of epoxide group to amino function.

The epoxy-functional siloxanes employed for this preferably contain 1 to 4, particularly preferably 2 epoxide groups per molecule. They furthermore have number-average molecular weights of from 150 to 2,000 g/mol, preferably from 250 to 1,500 g/mol, very particularly preferably from 250 to 1,250 g/mol.

Preferred epoxy-functional siloxanes are α,ω-epoxysiloxanes corresponding to the formula (III)

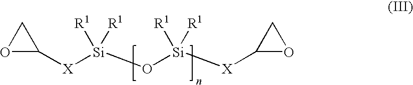

wherein
X is an aliphatic, optionally branched C1 to C10 radical, preferably —CH₂—, —CH₂CH₂—, —CH₂CH₂CH₂—, —CH(CH₃)CH₂—, —CH₂CH₂CH₂CH₂—, —CH₂CH₂CH(CH₃)— or —CH₂CH(CH₃)CH₂—, particularly preferably —CH₂—, or a —[CH₂O(CH₂)ᵣ]— unit, wherein r is an integer from 1 to 4, preferably 3, or a —[OCH₂CHZ]ₙO— unit wherein Z is H or methyl, and n is an integer from 1 to 12
R¹ is, identically or differently, H or a C1 to C10 hydrocarbon radical optionally containing hetero atoms and
n is 1 to 40.

R1 in the formulae (I) and (II) is preferably phenyl, alkyl, aralkyl, fluoroalkyl, alkylethylene-copropylene oxide groups or hydrogen, wherein phenyl or methyl groups are particularly preferred. R1 is very particularly preferably a methyl group.

Suitable compounds corresponding to formula (III) are, for example, those of the formulae IIIa) and IIIb):

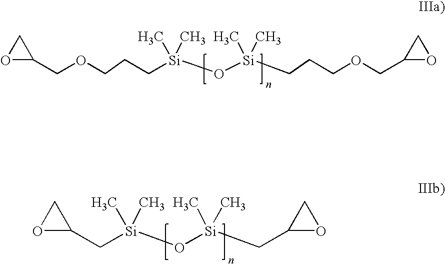

wherein
n is an integer from 4 to 12, preferably from 6 to 9.

Examples of commercially obtainable products of this series are, for example, CoatOsil® 2810 (Momentive Performance Materials, Leverkusen, Germany) or Tegomer® E-Si2330 (Tego Chemie Service GmbH, Essen, Germany).

Suitable hydroxyalkyl-functional amines correspond to the general formula (IV)

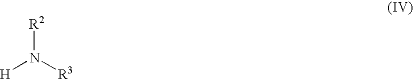

wherein
R2 is H or a methyl, ethyl, n-propyl, iso-propyl, cyclohexyl, 2-hydroxyethyl, 2-hydroxypropyl, or 3-hydroxypropyl radical, and
R3 is a 2-hydroxyethyl, 2-hydroxypropyl, or 3-hydroxypropyl radical.

Preferred hydroxyalkylamines are ethanolamine, propanolamine, diethanolamine, diisopropanolamine, methylethanolamine, ethylethanolamine, propylethanolamine and cyclohexylethanolamine. Diethanolamine, diisopropanolamine or cyclohexylethanolamine are particularly preferred. Diethanolamine is very particularly preferred.

For the preparation of component C), the epoxy-functional siloxane of the general formula (III) is optionally initially introduced into a solvent and then reacted with the required amount of the hydroxyalkylamine (IV) or a mixture of several hydroxyalkylamines (IV). The reaction temperature is typically 20 to 150° C. and is continued until no further free epoxide groups are detectable.

Hydroxyalkyl-functional siloxanes C) of the formula (I) which have been obtained by the abovementioned reaction of epoxy-functional polyorganosiloxanes with hydroxyalkylamines are particularly preferably employed.

Particularly preferred polyorganosiloxanes C) are, for example, those of the formulae Ia) to Ih):

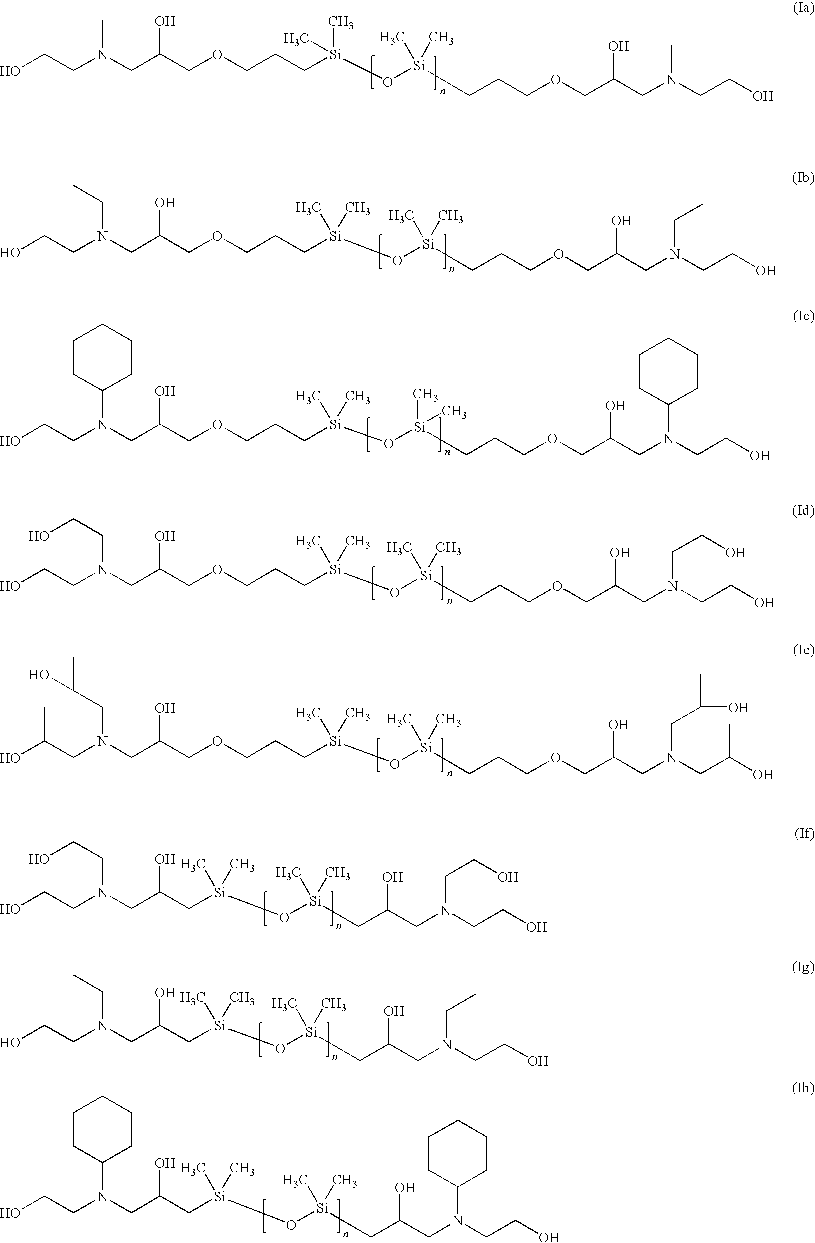

wherein n is an integer from 4 to 12, preferably from 6 to 9.

Siloxanes which are likewise suitable as component C) are, for example, hydroxyalkyl-functional siloxanes (α,ω-carbinols) corresponding to the formula (V)

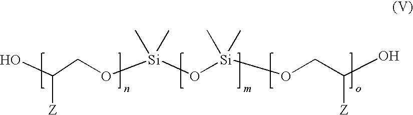

wherein
m is an integer from 5 to 15,
Z is H or methyl, preferably H, and
n and o are integers from 1 to 12, preferably from 1 to 5.

Hydroxyalkyl-functional siloxanes (α,ω-carbinols) of the formula (V) preferably have number-average molecular weights of from 250 to 2,250 g/mot, particularly preferably from 250 to 1,500 g/mol, very particularly preferably from 250 to 1,250 g/mol. Examples of commercially obtainable hydroxyalkyl-functional siloxanes of the type mentioned are Baysilone® OF—OH 502 3 and 6% strength (GE-Bayer Silicones, Leverkusen, Germany).

A further route for the preparation of suitable hydroxy-functional polyorganosiloxanes corresponding to component C) is the reaction of the abovementioned hydroxyalkyl-functional siloxanes of the α,ω-carbinol type of the formula (V) with cyclic lactones. Suitable cyclic lactones are, for example, ε-caprolactone, γ-butyrolactone or valerolactone.

This is effected in a ratio of OH groups to lactone functions of from 1:2 to 2:1, preferably in a stoichiometric ratio of OH groups to lactone functions. The hydroxyalkyl-functional siloxanes C) obtained in this way are preferred. Examples of such a compound are polyorganosiloxanes C) of the general formula (VI)

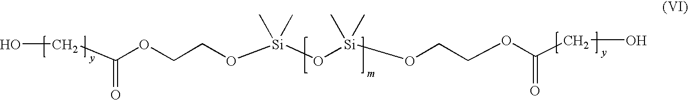

wherein
m is an integer from 5 to 15, and
y is an integer from 2 to 5, preferably 5.

Preferably R in formula (II) is a hydroxy-functional carboxylic ester of the formula

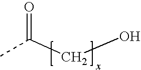

wherein x is an integer from 3 to 5, preferably 5,
or a hydroxyalkyl-functional amino group of the formula

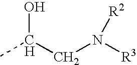

wherein
R² is an aliphatic linear, branched, or cyclic hydroxyalkyl radical, and
R³ is hydrogen or in conformity with the definition of the radical R².

With particular preference R in formula (II) is a hydroxyalkyl-functional amino group of the aforementioned kind.

R¹ in the formulae (II) and (III) is preferably phenyl, alkyl, aralkyl, fluoroalkyl, alkylethylene-co-propylene oxide groups or hydrogen, particular preference being given to phenyl and methyl. The two R¹ substituents on an Si atom may also be different. With very particular preference R¹ is a methyl group, and so the units in question are pure dimethylsilyl units.

The hydroxyl-containing siloxanes of component C) obtainable as described above preferably have number-average molecular weights of 250 to 2250 g/mol, more preferably 250 to 1500 gμmol.

In the modification the ratio between free NCO groups of the polyisocyanate to be modified that is used in A) and the NCO-reactive OH groups of the hydroxyl-containing polydimethylsiloxane of the formula (II) is preferably 1:0.001 to 1:0.4, more preferably 1:0.01 to 1:0.2.

Subsequent to the silane and polydimethylsiloxane modification it is possible for the free NCO groups of the polyisocyanates thus modified to be modified further. This may be, for example, partial or complete blocking of the free NCO groups with blocking agents known per se to the skilled person (on the blocking of isocyanate groups see DE-A 10226927, EP-A 0 576 952, EP-A 0 566 953, EP-A 0 159 117, U.S. Pat. No. 4,482,721, WO 97/12924 or EP-A 0 744 423). Examples include butanone oxime, ε-caprolactam, methyl ethyl ketoxime, malonic esters, secondary amines and also triazole derivatives and pyrazole derivatives.

Blocking the NCO groups before the nanoparticles are incorporated has the advantage that the nanoparticle-modified polyisocyanates based thereon tend to have a better stability in relation to the level of NCO groups subsequently available for crosslinking than do analogous products which still possess free NCO groups.

The modification of the polyisocyanates takes place preferably in the following order: polydimethylsiloxane, silane and blocking agent.

The reaction of hydroxyl-functional polydimethylsiloxane and polyisocyanate takes place at 0-100° C., preferably at 10-90° C., more preferably at 15-80° C. Where appropriate it is possible to use common catalysts which catalyze the reaction of R—OH with NCO.

In the process of the invention it is possible in principle to add at any time the solvents known per se to the skilled person that are inert towards NCO groups. These are, for example, solvents such as butyl acetate, 1-methoxy-2-propyl acetate, ethyl acetate, toluene, xylene, solvent naphtha and mixtures thereof.

During or subsequent to the modification of the polyisocyanate the nanoparticles E), surface-modified where appropriate, are introduced. This can be done by simple stirred incorporation of the particles. Also conceivable, however, is the use of elevated dispersing energy, such as by ultrasound, jet dispersing or high-speed stirrers operating on the rotor-stator principle, for example. Preference is given to simple mechanical stirred incorporation.

The particles can be used in principle not only in powder form but also in the form of suspensions or dispersions in suitable, preferably isocyanate-inert, solvents. Preference is given to using the particles in the form of dispersions in organic solvents.

Solvents suitable for the organosols are methanol, ethanol, isopropanol, acetone, 2-butanone, methyl isobutyl ketone, and also the solvents that are common in polyurethane chemistry, such as butyl acetate, ethyl acetate, 1-methoxy-2-propyl acetate, toluene, 2-butanone, xylene, 1,4-dioxane, diacetone alcohol, N-methylpyrrolidone, dimethylacetamide, dimethylformamide, dimethyl sulphoxide, methyl ethyl ketone or any desired mixtures of such solvents.

Preferred solvents in this context are the solvents that are common in polyurethane chemistry, such as butyl acetate, ethyl acetate, 1-methoxy-2-propyl acetate, toluene, 2-butanone, xylene, 1,4-dioxane, diacetone alcohol, N-methylpyrrolidone, dimethylacetamide, dimethylformamide, dimethyl sulphoxide, methyl ethyl ketone or any desired mixtures of such solvents.

Particularly preferred solvents are alcohol-free and ketone-free solvents such as butyl acetate, 1-methoxy-2-propyl acetate, ethyl acetate, toluene, xylene, solvent naphtha and mixtures thereof.

In relation to the level of NCO groups subsequently available for crosslinking it has proved to be advantageous to avoid the use of ketones or alcohols as solvents, not only for the particle dispersions but also as process solvents during the polyisocyanate modification, since in this case a comparatively higher reduction in the level of NCO groups is observed during the storage of the nanoparticle-modified polyisocyanates prepared therefrom. Where the polyisocyanates are blocked in an additional step, then ketones or alcohols may also be among the solvents used.

One preferred embodiment of the invention uses as particles in E) inorganic oxides, mixed oxides, hydroxides, sulphates, carbonates, carbides, borides and nitrides of elements from main groups II to IV and/or elements of transition groups I to VIII of the periodic table, including the lanthanides. Particularly preferred particles of component E) are silicon oxide, aluminium oxide, cerium oxide, zirconium oxide, zinc oxide, niobium oxide and titanium oxide. Very particular preference is given to silicon oxide nanoparticles.

The particles used in E) preferably have average particle sizes, determined by means of dynamic light scattering in dispersion as the Z-average, of 5 to 100 nm, more preferably 5 to 50 nm.

Preferably at least 75%, more preferably at least 90%, very preferably at least 95% of all the particles used in E) have the sizes defined above.

The particles are preferably used in surface-modified form. If the particles used in E) are to be surface-modified, they are reacted with silanization, for example, before being incorporated into the modified polyisocyanate. This method is known from the literature and described for example in DE-A 19846660 or WO 03/44099.

Furthermore, the surfaces may be modified adsorptively/associatively by surfactants with head groups corresponding interactions to the particle surfaces or block copolymers, as modified for example in WO 2006/008120 and Foerster, S. & Antonietti, M., Advanced Materials, 10, no. 3, (1998) 195.

Preferred surface modification is silanization with alkoxysilanes and/or chlorosilanes. With very particular preference the silanes in question carry, in addition to the alkoxyl groups, inert alkyl or aralkyl radicals, but no other functional groups.

Examples of commercial particle dispersions of the kind suitable for E) are Organosilicasol™ (Nissan Chemical America Corporation, USA), Nanobyk® 3650 (BYK Chemie, Wesel, Germany), Hanse XP21/1264 or Hanse XP21/1184 (Hanse Chemie, Hamburg, Germany), HIGHLINK® NanO G (Clariant GmbH, Sulzbach, Germany). Suitable organosols have a solids content of 10% to 60% by weight, preferably 15% to 50% by weight.

The amount of particles (calculated as solid) used in E), based on the overall system comprising modified polyisocyanate and particles, is typically 1% to 70% by weight, preferably 5 to 60, more preferably 25% to 55%.

The solids content of nanoparticle-containing polyisocyanates of the invention is 20% to 100%, preferably 40% to 90%, more preferably 40% to 70% by weight.

The invention further provides the nanoparticle-modified polyisocyanates obtainable in accordance with the invention, and also polyurethane systems comprising them.

Polyurethane systems of this kind can be formulated as 1-component or 2-component PU systems, depending on whether the NCO groups of the polyisocyanates of the invention are blocked.

Besides the nanoparticle-modified polyisocyanates of the invention the polyurethane systems of the present invention comprise polyhydroxy and/or polyamine compounds for crosslinking. In addition there may also be further polyisocyanates, different from the polyisocyanates of the invention, and also auxiliaries and additives present.

Examples of suitable polyhydroxyl compounds are tri- and/or tetra-functional alcohols and/or the polyether polyols, polyester polyols and/or polyacrylate polyols that are typical per se in coatings technology.

Furthermore it is also possible for crosslinking to use polyurethanes or polyureas which are crosslinkable with polyisocyanates on the basis of the active hydrogen atoms present in the urethane or urea groups respectively.

Likewise possible is the use of polyamines, whose amino groups may have been blocked, such as polyketimines, polyaldimines or oxazolanes.

For the crosslinking of the polyisocyanates of the invention it is preferred to use polyacrylate polyols and polyester polyols.

Auxiliaries and additives which can be used include solvents such as butyl acetate, ethyl acetate, 1-methoxy-2-propyl acetate, toluene, 2-butanone, xylene, 1,4-dioxane, diacetone alcohol, N-methylpyrrolidone, dimethylacetamide, dimethylformamide, dimethyl sulphoxide or any desired mixtures of such solvents. Preferred solvents are butyl acetate, 2-ethyl acetate and diacetoalcohol.

Further present as auxiliaries and additives may be such as inorganic or organic pigments, light stabilizers, coatings additives, such as dispersing, flow-control, thickening, defoaming and other auxiliaries, adhesion agents, fungicides, bactericides, stabilizers or inhibitors and catalysts.

The application of the polyurethane systems of the invention to substrates takes place in accordance with the application techniques that are typical within coatings technology, such as spraying, flow coating, dipping, spin coating or knife coating, for example.

All the references described above are incorporated by reference in their entireties for all useful purposes.

While there is shown and described certain specific structures embodying the invention, it will be manifest to those skilled in the art that various modifications and rearrangements of the parts may be made without departing from the spirit and scope of the underlying inventive concept and that the same is not limited to the particular forms herein shown and described.

### EXAMPLES

Unless noted otherwise, the percentages are to be understood as being by weight.

Desmophen® A 870 polyacrylate polyol, 70% in butyl acetate, OH number 97, OH content 2.95%, viscosity at 23° C. about 3500 mPas, commercial product of Bayer MaterialScience AG, Leverkusen, DE

Desmodur® N 3300: hexamethylene diisocyanate trimer; NCO content 21.8+/−0.3% by weight, viscosity at 23° C. about 3000 mPas, Bayer MaterialScience AG, Leverkusen, DE

Desmodur® N 3390 BA: hexamethylene diisocyanate trimer in butyl acetate; NCO content 19.6+/−0.3% by weight, viscosity at 23° C. about 500 mPas, Bayer MaterialScience AG, Leverkusen, DE

Desmodur® VP LS 2253: 3,5-dimethylpyrazole-blocked polyisocyanate (trimer) based on HDI; 75% in SN 100/MPA (17:8), viscosity at 23° C. about 3600 mPas, blocked NCO content 10.5%, equivalent weight 400, Bayer MaterialScience AG, Leverkusen, DE

Organosilicasol™ MEK-ST: colloidal silica dispersed in methyl ethyl ketone, particle size 10-15 nm (manufacturer's datum), 30 wt % SiO₂, <0.5 wt % H₂O, <5 mPa s viscosity, Nissan Chemical America Corporation, USA.

Coatosil® 2810: Epoxy-modified silicone fluid, epoxide content 11.4%. Momentive Performance Materials, Leverkusen, DE.

Baysilone®-Lackadditiv OL 17: flow control assistant, Borchers GmbH, Langenfeld, DE)

BYK® 070: defoamer, BYK-Chemie GmbH, Wesel, DE

Tinuvin® 123: HALS amine, Ciba Specialty Chemicals, Basel, CH

Tinuvin® 384-2: UV absorber, Ciba Specialty Chemicals, Basel, CH

Solventnaphtha® 100: aromatics-containing solvent mixture, Bayer MaterialScience AG, Leverkusen, DE

The hydroxyl number (OH number) was determined in accordance with DIN 53240-2.

The viscosity was determined using a “RotoVisco 1” rotational viscometer from Haake, Germany in accordance with DIN EN ISO 3219.

The acid number was determined in accordance with DIN EN ISO 2114.

The colour number (APHA) was determined in accordance with DIN EN 1557.

The NCO content was determined in accordance with DIN EN ISO 11909.

Pendulum damping (König) to DIN EN ISO 1522 “Pendulum attenuation testing”

Chemical resistance to DIN EN ISO 2812-5 “Coating Materials—Determination of Resistance to Liquids—Part 5: Method with the Gradient Oven”

Scratch resistance, laboratory wash unit (wet marring) to DIN EN ISO 20566 “Coating Materials—Testing of the Scratch Resistance of a Coating System using a Laboratory Wash Unit”

### Determination of Particle Size

The particle sizes were determined by means of dynamic light scattering using an HPPS particle size analyzer (Malvern, Worcestershire, UK). Evaluation was made via the Dispersion Technology Software 4.10. In order to prevent multiple scattering a highly dilute dispersion of the nanoparticles was prepared. One drop of dilute nanoparticle dispersion (approximately 0.1%-10%) was placed in a cell containing about 2 ml of the same solvent as the dispersion, shaken and measured in the HPPS analyzer at 20 to 25° C. As is general knowledge to the skilled person, the relevant parameters of the dispersion medium—temperature, viscosity and refractive index—were entered into the software beforehand. In the case of organic solvents a glass cell was used. The result obtained was an intensity/ or volume/particle diameter plot and also the Z-average for the particle diameter. Attention was paid to the polydispersity index being <0.5.

### Determination of Solvent Resistance

This test was used to determine the capacity of a cured coating film to resist a variety of solvents. This is done by allowing the solvent to act on the coating surface for a defined time. Subsequently an assessment is made, both visually and by feeling with the hand, as to whether and, if so, which changes have occurred on the area under test. The coating film is generally located on a glass plate; other substrates are likewise possible. The test tube stand with the solvents xylene, 1-methoxyprop-2-yl acetate, ethyl acetate and acetone (see below) is placed onto the surface of the coating so that the openings of the test tubes with the cotton wool plugs are lying on the film. The important factor is the resultant wetting of the coating surface by the solvent. Following the specified solvent exposure times of 1 minute and 5 minutes, the test tube stand is removed from the coating surface. Subsequently the solvent residues are removed immediately by means of an absorbent paper or cloth fabric. The area under test is then immediately inspected, after careful scratching with the fingernail, visually, for changes. The following gradations are differentiated:

| | |
|---|---|
| 0 = unchanged | |
| 1 = trace changed | visible change only |
| 2 = slightly changed | tangible softening perceptible with fingernail |
| 3 = markedly changed | severe softening perceptible with the fingernail |
| 4 = severely changed | with the fingernail down to the substrate |
| 5 = destroyed | coating surface destroyed without external |
| | exposure |

The evaluation stages found for the solvents indicated above are documented in the following order:

| | | |
|---|---|---|
| Example | 0000 | (no change) |
| Example | 0001 | (visible change only in the case of |
| | | acetone) |

The numerical sequence here describes the sequence of solvents tested (xylene, methoxypropyl acetate, ethyl acetate, acetone)

### Determination of Scratch Resistance by Means of Hammer Test (Dry Marring)

The marring is carried out using a hammer (weight: 800 g without shaft) whose flat side is mounted with steel wool or polishing paper. The hammer is placed carefully at right angles to the coated surface and is drawn over the coating in a track without tipping and without additional physical force. 10 back-and-forth strokes are performed. Following exposure to the marring medium, the area under test is cleaned with a soft cloth and then the gloss to DIN EN ISO 2813 is measured transversely to the direction of marring. The regions measured must be homogeneous.

### Example 1

Diethyl N-(3-trimethoxysilylpropyl)aspartate was prepared, in accordance with the teaching from U.S. Pat. No. 5,364,955, Example 5, by reacting equimolar amounts of 3-aminopropyltrimethoxysilane with diethyl maleate.

### Example 2a

### Hydroxyl-Functional Polydimethylsiloxane

In accordance with WO 2007025670, 770 g of the epoxy-functional polydimethylsiloxane Coatsosil® 2810

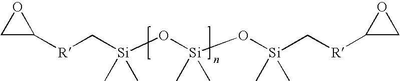

were introduced, preheated to 80° C. and admixed with 231 g of diethanolamine (equivalent ratio epoxide/amine 1:1). This mixture was subsequently stirred at 100° C. for 2 hours. The product had an epoxide content <0.01%, an OH number of about 365 mg KOH/g (11.1%) and a viscosity at 23° C. of about 2900 mPas.

### Example 2b-2c

In the same way as in Example 2a, the reaction of the bisepoxide was carried out with different amines. The epoxide contents after the reaction had subsided were <0.01%. In some cases the synthesis was carried out in the presence of butyl acetate.

| | | Butyl | |
|---|---|---|---|
| | | acetate | OH number |
| Example | Amine | [%] | [mg KOH/g] |
| 2a | Diethanolamine | — | 365 |
| 2b | 2-Ethylaminoethanol | — | 249 |
| 2c | Cyclohexylaminoethanol | 25 | 116 |

### Example 2d

438 g (2 eq) of the PDMS bishydroxide Tegomer H—Si2111 (OH content 3.9%, molar mass 876 g/mol; Degussa AG, Essen, DE) were mixed with 57 g of caprolactone (1 eq) and 0.05% w/w of DBTL and stirred at 150° C. for 6 h. This gave a transparent product having an OH number of 113 mg KOH/g.

### Example 3

A 2 l flask was charged with 500 g of Organosilicasol™ MEK-ST and 500 g of butyl acetate. The dispersion was concentrated on a rotary evaporator at 60° C. and 120 mbar and the residue was made up again with 500 g of butyl acetate. This procedure was repeated until the methyl ethyl ketone fraction of the dispersion had dropped to <0.1% by weight (determined by means of GC-FID).

Both the Organosilicasol™ MEK-ST used in Example 3 and the butyl acetate and the resulting dispersion in butyl acetate were dried in each case using 4 A molecular sieve.

The water content of the resulting silica organosol in butyl acetate was 440 ppm. The solids content was adjusted to 30% by weight. The Z-average as determined via dynamic light scattering was 23 nm.

### Example 5

### Comparative Polyisocyanate According to DE 10 2006 054289

A standard stirring apparatus was charged with 192.7 g (1 eq) of Desmodur® N3300 (hexamethylenediisocyanate trimer; NCO content 21.8+/−0.3% by weight, viscosity at 23° C. about 3000 mPas, Bayer MaterialScience AG, Leverkusen, DE) in 85 g of butyl acetate at 60° C. Then 70.3 g (0.2 eq) of the alkoxysilane from Example 1 were cautiously added dropwise, the temperature being held at not more than 60° C. After the end of the reaction (examination of the NCO content for constancy by IR spectroscopy) the batch was cooled to RT and 76.9 g of 1,3-dimethylpyrrazole (DMP) were added cautiously and the temperature was held at 50° C. until the NCO peak had disappeared in the IR spectrometer.

This gave a colourless, liquid, blocked polyisocyanate having the following characteristics: solids content 80% by weight, viscosity 3440 mPas at 23° C., and 7.91% blocked NCO content based on DMP.

### Example 6a

### Inventively Essential Silane- and Siloxane-Modified PIC

A standard stirring apparatus was charged with 275.85 g (1 eq) of Desmodur® N3300 in 250 g of butyl acetate at 80° C. and blanketed with 2 l/h nitrogen. Subsequently 4.41 g (0.02 eq) of the siloxane block copolyol from Example 2a were added at 80° C. and the temperature was held for 4 h. The theoretically expected NCO content was examined by titrimetry and then the batch was cooled to room temperature. Over the course of 3 h 112.88 g (0.2 eq) of the alkoxysilane from Example 1 and also 250 g of butyl acetate were added, the temperature being held below 40° C. by means of ice cooling. After the theoretical NCO content had been examined, the batch was cooled to RT and, over about 15 min, 106.87 g (0.78 eq) of the dimethylpyrrazole blocking agent were added, with the temperature regulated at not more than 40° C. The temperature was held at 40° C. until the NCO peak had disappeared in the IR spectrometer.

This gave a clear, liquid, blocked polyisocyanate having the following characteristics: solids content 48.7% by weight and 4.67% blocked NCO content based on DMP.

### Example 6b to 6h

In the same way as for Example 6a, further modified PICs essential to the invention were prepared. The polyisocyanate used was Desmodur N3300. Where appropriate the polysiloxane unit was mixed with 50 g of butyl acetate. The PIC/polysiloxane/silane/blocking agent equivalent ratios were chosen to be 1/0.02/0.2/0.78. Clear, storage-stable products were obtained.

| | | | Blocking | NCO | SC |
|---|---|---|---|---|---|
| Ex. | Polysiloxane | Silane | agent | [%] | [%] |
| 6a | Example 2a | Example 1 | DMP | 4.67 | 48.7 |
| 6b | Example 2b | Example 1 | DMP | 4.78 | 48.4 |
| 6c | Example 2c | Example 1 | DMP | 4.65 | 48.7 |
| 6d | Example 2d | Example 1 | DMP | 4.57 | 48.1 |
| 6e | Baysilon OF/OH 3% | Example 1 | DMP | 4.56 | 47.5 |
| | (Bayer/GE-Silicones, | | | | |
| | Leverkusen, DE) | | | | |
| 6f | Baysilon OF/OH 6% | Example 1 | DMP | 4.64 | 47.6 |
| | (Bayer/GE-Silicones, | | | | |
| | Leverkusen, DE) | | | | |
| 6g | Example 2a | Example 1 | Butanone | 4.91 | 48.9 |
| | | | oxime | | |
| 6h | Example 2a | Dynasilan 1189 | DMP | 5.13 | 48.5 |
| | | (Degussa AG, | | | |
| | | Marl, DE) | | | |

NCO content: based on blocking agent

### Example 7

### Siloxane-Modified Comparative Polyisocyanate without Aminosiloxane Modification

A standard stirring apparatus was charged with 332.73 g (1 eq) of Desmodur® N3300 in 250 g of butyl acetate at 80° C. and blanketed with 2 l/h nitrogen. Subsequently 5.31 g (0.02 eq) of the siloxane block copolyol from Example 2 were added at 80° C. and the temperature was held for 4 h. The theoretically expected NCO content was examined by titrimetry and then the batch was cooled to room temperature and 250 g of butyl acetate were added. After the theoretical NCO content had been examined, the batch was cooled to to RT and, over about 15 min, 161.95 g (0.98 eq) of the dimethylpyrrazole blocking agent were added, with the temperature regulated at not more than 40° C. The temperature was held at 40° C. until the NCO peak had disappeared in the IR spectrometer.

This gave a hazy, floccular, blocked polyisocyanate having the following characteristics: solids content 49.7% by weight and 7.08% blocked NCO content based on DMP.

### Example 8a

### Comparative Polyisocyanate, Containing Nanoparticles

344.2 g of the product from Example 5 were charged to a standard stirring apparatus and admixed with 955.8 g of Organosilicasol™ MEK-ST over the course of 30 min. The resultant modified polyisocyanate had an NCO content of 2.1% by weight with a solids content of 42.7% by weight. The fraction of SiO₂ nanoparticles in the dispersion was 22% by weight and 50.8% by weight in the solid. The product was slightly hazy and somewhat yellowish.

Subsequently 262 g of solvent were removed from 845 g of this product on a rotary evaporator at 60° C. and 120 mbar under reduced pressure. The resulting solids was 62.3% and the NCO content was 3.01%.

### Example 8b

### Comparative Polyisocyanate, Containing Nanoparticles

344.2 g of the product from Example 5 were charged to a standard stirring apparatus and admixed with 955.8 g of Organosilicasol from Example 3 over the course of 30 min. The resultant modified polyisocyanate was transparent and had an NCO content of 1.8% by weight with a solids content of 37.1% by weight. The fraction of SiO₂ nanoparticles in the dispersion was 22.1% by weight and 51% by weight in the solid. The product was clear and somewhat yellowish.

Subsequently 374 g of solvent were removed from 895 g of this product on a rotary evaporator at 60° C. and 120 mbar under reduced pressure. The resulting solids was 65.0% and the NCO content was 3.13%.

### Example 9

### Inventive Polyisocyanate, Containing Nanoparticles

187.57 g of the product from Example 6a were charged to a standard stirring apparatus and admixed with 312.43 g of Organosilicasol as per Example 3 over the course of 30 min. The resultant modified, blocked polyisocyanate was liquid and transparent and had a blocked NCO content of 1.81% by weight with a solids content of 37.01% by weight. The fraction of SiO₂ nanoparticles in the dispersion was 18.7% by weight and 50.6% by weight in the solid. The storage stability was >3 months.

### Example 10

### Inventive Polyisocyanate, Containing Nanoparticles

1487.5 g of the product from Example 6 were charged to a standard stirring apparatus and admixed with 2512.48 g of Organosilicasol MEK-ST (Nissan Chem. Corp.) over the course of 30 min. The resultant modified, blocked polyisocyanate was liquid and transparent and had a blocked NCO content of 1.74% by weight with a solids content of 37.44% by weight. The fraction of SiO₂ nanoparticles in the dispersion was 18.8% by weight and 50.4% by weight in the solid.

### Example 11

### Inventive Polyisocyanate, Containing Nanoparticles

140.3 g of solvent were removed from 340.3 g of the product from Example 9 on a rotary evaporator at 60° C. and 120 mbar. The resultant nanoparticle-containing polyisocyanate was transparent and had a blocked NCO content of 3.18% by weight with a solids content of 67.1% by weight. The fraction of SiO₂ nanoparticles in the dispersion was 31.8% by weight and 50.6% by weight in the solid. The viscosity at 23° C. was 1620 mPas. The storage stability was >3 months.

### Example 12

### Inventive Polyisocyanate, Containing Nanoparticles

289 g of solvent were removed from 771.3 g of the product from Example 10 on a rotary evaporator at 60° C. and 120 mbar. The resultant nanoparticle-containing polyisocyanate was transparent and had a blocked NCO content of 2.86% by weight with a solids content of 61.5% by weight. The fraction of SiO₂ nanoparticles in the dispersion was 30.9% by weight and 50.4% by weight in the solid.

### Example 13a-g Inventive Polyisocyanates, Containing Nanoparticles

In the same way as in Example 9, further inventive polyisocyanates containing nanoparticles were prepared and, where appropriate, solvents were removed by distillation. This gave clear, liquid products.

| | | | NCO | SC |
|---|---|---|---|---|
| Example | Polyisocyanate | Organosol | [%] | [%] |
| 13a | 6b | Example 3 | 2.86 | 62.2 |
| 13b | 6c | Organosol MEK-ST | 1.78 | 37 |
| 13c | 6d | Organosol MEK-ST | 1.78 | 36.8 |
| 13d | 6e | Organosol MEK | 1.8 | 36.9 |
| 13e | 6f | Organosol MEK | 1.82 | 36.6 |
| 13f | 6g | Example 3 | 2.88 | 60.1 |
| 13g | 6h | Example 3 | 1.86 | 37.2 |

### Example 14

### Comparative Polyisocyanate According to DE 10 2006 054289

A standard stirred apparatus was charged with 453.6 g (1 eq) of Desmodur® N3300 in 80 g of butyl acetate at room temperature and blanketed with nitrogen at 2 l/h. Then, over the course of 3 h at room temperature, 186.5 g (0.2 eq) of the alkoxysilane from Example 1 in 80 g of butyl acetate were added dropwise.

This gave a colourless, liquid polyisocyanate having the following characteristics: solids content 80% by weight, 9.58% NCO content.

### Example 15

### Siloxane-Containing Comparative Polyisocyanate

A standard stirring apparatus was charged with 492.1 g (1 eq) of Desmodur® N3300 in 250 g of butyl acetate at 80° C. and blanketed with 2 l/h nitrogen. Subsequently 7.86 g (0.02 eq) of the siloxane block copolyol from Example 2a were added at 80° C. and the temperature was held for 4 h. The theoretically expected NCO content was examined by titrimetry and then the batch was cooled to room temperature and 250 g of butyl acetate added.

This gave a clear polyisocyanate having the following characteristics: solids content 50.3% by weight and 10.4% NCO content.

### Example 16

### Inventively Essential Silane- and Siloxane-Modified PIC

A standard stirring apparatus was charged with 350.8 g (1 eq) of Desmodur® N3300 in 250 g of butyl acetate at 80° C. and blanketed with 2 l/h nitrogen. Subsequently 5.60 g (0.02 eq) of the siloxane block copolyol from Example 2a were added at 80° C. and the temperature was held for 4 h. The theoretically expected NCO content was examined by titrimetry and then the batch was cooled to room temperature. Over the course of 3 h 143.6 g (0.2 eq) of the alkoxysilane from Example 1 and also 250 g of butyl acetate were added, the temperature being held below 40° C. by means of ice cooling. After the theoretical NCO content had been examined, the batch was cooled to RT.

This gave a clear, liquid polyisocyanate having the following characteristics: solids content 50.6% by weight and 5.75% NCO content.

### Example 17

### Comparative Polyisocyanate, Containing Nanoparticles

129.6 g of the product from Example 14 in 77.8 g of butyl acetate were charged to a standard stirring apparatus and admixed with 392.7 g of Organosilicasol™ MEK-ST (Nissan Chemicals Corp.) over the course of 30 min. The resultant nanoparticle-modified polyisocyanate was liquid and transparent and had an NCO content of 1.76% by weight with a solids content of 37.2% by weight. The fraction of SiO₂ nanoparticles in the dispersion was 19.6% by weight and 53.2% by weight in the solid.

### Example 18

### Comparative Polyisocyanate, Containing Nanoparticles

136.3 g of the product from Example 15 were charged to a standard stirring apparatus and admixed with 363.7 g of Organosilicasol from Example 3 over the course of 30 min. The resultant modified, blocked polyisocyanate was translucent and had an NCO content of 2.81% by weight with a solids content of 36.2% by weight and underwent gelling after 1 day. The fraction of SiO₂ nanoparticles in the dispersion was 21.8% by weight and 61% by weight in the solid.

### Example 19

### Inventive Polyisocyanate, Containing Nanoparticles

173.4 g of the product from Example 16 were charged to a standard stirring apparatus and admixed with 326.6 g of Organosilicasol from Example 3 over the course of 30 min. The resultant modified, blocked polyisocyanate was transparent and had an NCO content of 1.94% by weight with a solids content of 37.5% by weight. The fraction of SiO₂ nanoparticles in the dispersion was 19.6% by weight and 52.8% by weight in the solid. The storage stability until getting was approximately 1 month.

### Performance Testing of the Blocked Polyisocyanates:

The inventive polyisocyanate from Example 9 was blended with Desmophen® A870 BA in the NCO/OH ratios of 1.0 and with 0.1% of Baysilone OL 17 (solids/binder solids. 10% strength solution in MPA), 2.0% of BYK 070 (as-supplied form/binder solids), 1.0% of Tinuvin 123 (as-supplied form/binder solids), 1.5% of Tinuvin 384-2 (as-supplied form/binder solids) and 0.5% of DBTL (solids/binder solids, 10% strength solution in MPA) as coatings additives and the components were stirred together thoroughly. The solids of the coating materials were between 40% and 50% and were adjusted where appropriate with a 1:1 MPA/SN solvent mixture. Before being processed the coating material was deaerated for 10 minutes. The coating material was then applied to the prepared substrate using a gravity-feed cup-type gun in 1.5 cross-passes (3.0-3.5 bar air pressure, nozzle: 1.4-1.5 mm 0, nozzle/substrate distance: about 20-30 cm). After a flash-off time of 15 minutes the coating material was baked at 140° C. for 30 minutes. The dry film thickness was in each case 30-45 μm. The results are compiled in Table 2.

For the purpose of comparison a conventional coating system comprising Desmophen® A 870 and Desmodur® VP LS 2253 and also the comparative polyisocyanates from Examples 5 and 6 was formulated with coatings additives (Table 1) and applied in the same way. The results are likewise compiled in Table 2.

TABLE 2a
Comparison of the coatings-technological properties, of blocked polyisocyanates

| Polyisocyanate | Ex. 9 | Ex. 6 | LS 2253 | Ex. 5 |
|---|---|---|---|---|
| König pendulum damping [s] | 192 | 189 | 189 | 169 |
| Solvent resistance (X/MPA/EA/Ac)[rating]¹⁾ | | | | |
| 5 min. | 0024 | 1244 | 1255 | 1144 |
| Chemical resistance (gradient oven)[° C.] | | | | |
| Tree resin | 40 | 36 | 36 | 36 |
| DI water | 62 | 52 | 46 | 59 |
| NaOH, 1% | 44 | 40 | 43 | 43 |
| H₂SO₄, 1% | 45 | 44 | 45 | 43 |
| FAM, 10 min. [Rating]¹⁾ | 0 | 0 | 0 | 2 |
| Scratch resistance | | | | |
| Amtec Kistler laboratory wash unit | | | | |
| Initial gloss 20° | 86.1 | 87.5 | 88.4 | 87.0 |
| Loss of gloss (Δgloss) after 10 wash cycles | 19.2 | 27.6 | 35.7 | 22.8 |
| 20° | | | | |
| Relative residual gloss [%] | 77.7 | 68.5 | 59.6 | 73.8 |
| Relative residual gloss after reflow 2 h 60° C. | 87.2 | 83.5 | 82.4 | 87.2 |
| [%] | | | | |
| Hammer test + steel wool | | | | |
| Initial gloss 20° | 86.1 | 87.5 | 88.4 | |
| Loss of gloss (Δgloss) after 10 back-and-forth | 16.1 | 58.2 | 62.2 | |
| strokes 20° | | | | |
| Relative residual gloss [%] | 81.3 | 33.5 | 29.6 | |
| Relative residual gloss after reflow 2 h 60° C. | 97.7 | 84.6 | 91.9 | |
| [%] | | | | |
| Hammer test + polishing paper | | | | |
| Initial gloss 20° | 86.1 | 87.5 | 88.4 | |
| Loss of gloss (Δgloss) after 10 back-and-forth | 8.0 | 55.8 | 54.9 | |
| strokes 20° | | | | |
| Relative residual gloss [%] | 90.7 | 36.2 | 37.9 | |
| Relative residual gloss after reflow 2 h 60° C. | 99.5 | 90.3 | 92.5 | |
| [%] | | | | |

¹⁾0 - good; 5 - poor

The inventively modified, blocked PIC containing SiO₂ nanoparticles from Example 9 shows improvements, in comparison to the modified polyisocyanates from Examples 5 and 6 and also to the DMP-blocked polyisocyanate LS 2253, in solvent-resistance, water resistance and in dry and wet marring both before and after reflow. The other properties were retained.

In a further series of tests, aminosilane-modified, nanoparticle-containing polyisocyanates (DE 10 2006 054289) were compared with inventive amino- and polysiloxane-modified, nanoparticle-containing polyisocyanates. The procedure for doing this was similar to that described above. Curing took place with Desmophen A870 with an NCO ratio of 1:1. The coating materials, however, were adjusted by means of MPA/SN100 (1:1) to efflux viscosities between 20 and 25 see, and not to a solids content. This resulted in spray solids of 40% to 60%. Drying was at RT for 30 minutes, then at 140° C. for 30 minutes, and subsequently at 60° C. for 16 hours. The results are set out in Table 2b.

TABLE 2b
Comparison of the coatings-technological properties of the inventive
blocked polyisocyanates with the batch from DE 10 2006 054289

| Polyisocyanate | D'dur LS 2253 | EX. 12 I | Ex. 8a C | EX. 8b C |
|---|---|---|---|---|
| SC % | 75.0 | 61.5 | 62.3 | 65 |
| NCO % | 10.5 | 2.86 | 4.83 | 3.13 |
| Composition coating material | | | | |
| Desmophen A 870 | 75.3 | 40.0 | 41.1 | 41.0 |
| Baysilone OL 17 (10% strength, | 0.9 | 0.9 | 0.9 | 0.9 |
| MPA) | | | | |
| Byk 070 | 0.9 | 0.9 | 0.9 | 0.9 |
| Tinuvin 123 | 0.9 | 0.9 | 0.9 | 0.9 |
| Tinuvin 384-2 | 1.4 | 1.4 | 1.4 | 1.4 |
| Total comp. 1 | 79.4 | 44.1 | 45.2 | 45.1 |
| Desmodur VP LS 2253 | 51.5 | | | |
| Example 12 | | 101.8 | | |
| Example 8a | | | 99.3 | |
| Example 8b | | | | 95.3 |
| Total comp. 1 + 2 | 130.9 | 145.9 | 144.5 | 140.4 |
| MPA/SN100 (1:1) visc. | 58.6 | 98.6 | 9.4 | 32.1 |
| Viscosity DIN4 in s | 20 | 23 | 22 | 20 |
| Gloss/haze before marring | 89.6/9.7 | 87.5/8.5 | 73.6/97.3 | 87.7/9.1 |
| Dry scratch resistance | | | | |
| Residual gloss after exposure | 32.1 | 70.4 | N.B.: | 61.4 |
| Residual gloss after reflow | 82.3 | 84.4 | unmeasurable | 85.1 |
| Pendulum hardness RT in sec | 203 | 207 | 185 | 202 |
| Resistances | | | | |
| Xylene | 3 | 0-1 | 0-1 | 1-2 |
| MPA | 3 | 0-1 | 1 | 2 |
| Ethyl acetate | 3-4 | 3-4 | 3-4 | 3-4 |
| Acetone | 3-4 | 3-4 | 3-4 | 3-4 |
| FAM | 2 | 0-1 | 0-1 | 1 |
| Visual assessment directly | satisfactory | satisfactory | poor flow | satisfactory |
| after coating | | | | |

In the formulation employed, the inventively modified, nanoparticle-containing polyisocyanate from Example 12 exhibits improved scratch resistance, pendulum hardness and also flow, gloss and haze in comparison to the aminosilane-modified, nanoparticle-containing polyisocyanate corresponding to DE 10 2006 054289 (Example 8a). By using the organosol from Example 3 in accordance with Example 8b it was indeed possible to achieve a distinct improvement in the scratch resistance and pendulum hardness of the polyisocyanate corresponding to DE 10 2006 054289, but it was not possible to achieve the level of the inventive polyisocyanate. In principle, dry scratch resistance and solvent resistance can be improved through inventive polyisocyanate as compared with the nanoparticle-free comparison.

TABLE 2c
Comparison of the coatings-technological properties of the inventive
blocked polyisocyanates, different siloxane unit

| Polyisocyanate | D'dur VP LS 2253 | Example 13a |
|---|---|---|
| SC % | 75 | 62.2 |
| NCO % | 10.5 | 2.86 |
| NCO:OH | 1.0 | 1.0 |
| Desmodur A 870 | 80.0 | 42.8 |
| Baysilone OL 17 (10% | 1.0 | 1.0 |
| strength MPA) | | |
| Byk 070 | 1.0 | 1.0 |
| DBTL (1% strength in BuAc) | 1.0 | 1.0 |
| Tinuvin 123 | 1.0 | 1.0 |
| Tinuvin 384-2 | 1.4 | 1.4 |
| Total comp. 1 | 85.4 | 48.2 |
| Desmodur VP LS 2253 | 55.4 | |
| Example 13a | | 108.8 |
| Total comp. 1 + 2 | 140.8 | 157.0 |
| MPA/SN100 (1:1) visc. | 53.1 | 40.2 |
| Viscosity DIN4 in s | 24 | 18 |
| Solids in % | 52.2 | 51.3 |
| Gloss/haze before marring | 90.8/8.1 | 85.4/10.7 |
| Scratch resistance | | |
| Residual gloss after exposure | 32.3 | 63.8 |
| Residual gloss after reflow | 60.6 | 79.3 |
| Pendulum hardness RT in sec | 181 | 190 |

Inventive, nanoparticle-containing polyisocyanate shows a distinctly increased scratch resistance and pendulum hardness in comparison to the standard.

### Performance Testing of the Non-Blocked Polyisocyanates:

General conditions MMT 79-72/1, 2, 5, 6 and also MMT 79-57/6:

A 870 BA, catalyst-free, 40-50% spray solids content, 25 min at 140° C.+16 h at 60° C. baking conditions, clearcoat film thickness 35-52 μm, clear coating materials, visually satisfactory.

### Performance Testing

The inventive polyisocyanate from Example 16 was blended with Desmophen® A 870 BA in the NCO/OH ratios of 1:0 and also coatings additives (Table 3) and the components were stirred together thoroughly. The solids of the coating materials were between 40% and 50% and were adjusted where appropriate with a 1:1 MPA/SN solvent mixture. Before being processed the coating material was deaerated for 10 minutes. The coating material was then applied to the prepared substrate using a gravity-feed cup-type gun in 1.5 cross-passes (3.0-3.5 bar air pressure, nozzle: 1.4-1.5 mm Ø, nozzle/substrate distance: about 20-30 cm). After a flash-off time of 15 minutes the coating material was baked at 140° C. for 25 minutes. The dry film thickness was in each case 30-45 μm. After conditioning/ageing at 60° C. for 16 h, coatings testing was commenced. The results are compiled in Table 4.

For the purpose of comparison a conventional coating system comprising Desmophen® A 870 and Desmodur® N 3390 and also the modified, nanoparticle-free polyisocyanates from Example 12 to 14 was formulated with coatings additives (Table 3) and applied in the same way. The results are likewise compiled in Table 4.

TABLE 3
Amounts used of additives
Standard 2K [2-component] PU coating materials:

| | |
|---|---|
| 0.1% | Baysilone OL 17 (solids/binder solids), used as 10% strength |
| | solution in MPA |
| 2.0% | BYK 070 (as-supplied form/binder solids) |
| 1.0% | Tinuvin 123 (as-supplied form/binder solids) |
| 1.5% | Tinuvin 384-2 (as-supplied form/binder solids) |

TABLE 4
Comparison of the coatings-technological properties, of 2K, non-blocked
polyisocyanates

| Polyisocyanate | Ex. 14 | Ex. 15 | Ex. 18 | N 3390 | Ex. 16 |
|---|---|---|---|---|---|
| König pendulum damping [s] | 179 | 181 | 181 | 185 | 67 |
| Solvent resistance | | | | | |
| (X/MPA/EA/Ac)[Rating]¹⁾ | 1145 | 1144 | 2234 | 1024 | 4455 |
| 5 min. | | | | | |
| Chemical resistance (gradient oven)[° C.] | | | | | |
| DI water | 44 | 49 | >68 | 48 | |
| Scratch resistance | | | | | |
| Amtec Kistler laboratory wash unit | | | | | |
| Initial gloss 20° | 88.4 | 87.5 | 85.8 | 88.0 | |
| Loss of gloss (Δgloss) after 10 wash cycles | 38.0 | 25.0 | 24.1 | 31.4 | |
| 20° | | | | | |
| Relative residual gloss [%] | 57.0 | 71.4 | 71.9 | 64.3 | |
| Relative residual gloss after reflow 2 h 60° C. | 84.7 | 85.6 | 82.4 | 87.6 | |
| [%] | | | | | |
| Hammer test + steel wool | | | | | |
| Initial gloss 20° | 88.4 | 87.5 | 85.8 | 88.0 | |
| Loss of gloss (Δgloss) after 10 back-and-forth | 64.2 | 66.4 | 16.6 | 58.7 | |
| strokes 20° | | | | | |
| Relative residual gloss [%] | 27.4 | 24.1 | 80.7 | 33.3 | |
| Relative residual gloss after reflow 2 h 60° C. | 89.1 | 83.1 | 95.3 | 86.4 | |
| [%] | | | | | |
| Hammer test + polishing paper | | | | | |
| Initial gloss 20° | 88.4 | 87.5 | 85.8 | 88.0 | |
| Loss of gloss (Δgloss) after 10 back-and-forth | 74.2 | 63.5 | 4.6 | 62.3 | |
| strokes 20° | | | | | |
| Relative residual gloss [%] | 16.1 | 27.4 | 94.6 | 29.2 | |
| Relative residual gloss after reflow 2 h 60° C. | 83.4 | 85.9 | 99.5 | 90.1 | |
| [%] | | | | | |

¹⁾0 - good; 5 - poor

The inventively modified polyisocyanate containing SiO₂ nanoparticles from Example 18 shows improvements in water resistance and dry marring, both before and after reflow, in comparison to the pure polyisocyanate (standard 2K). The wet marring before reflow was likewise improved. In comparison to DE 10 2006 054289 (Ex. 16) it was possible to improve the solvent resistance and the pendulum hardness.

1. A process for preparing a nanoparticle-modified polyisocyanate, comprising reacting
A) a polyisocyanate with
B) an alkoxysilane of formula (I)
Q-Z-SiXₐY₃₋ₐ (I)
wherein
Q is an isocyanate-reactive group,
X is a hydrolysable group,
Y is identical or different alkyl groups,
Z is a C₁-C₁₂ alkylene group, and
a is an integer from 1 to 3;
C) a hydroxyl-containing polysiloxane of formula (II) and having an number-average molecular weight in the range of from 200 to 3000 g/mol and an average OH functionality of greater than or equal to 1.8: 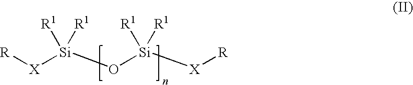
wherein
X is an aliphatic, optionally branched C1 to C10 radical; or
a —[OCH₂CHZ]ₙO— unit, wherein Z is H or methyl, and n is an integer from 1 to 12; or
a —CH₂—O—(CH₂)ᵣ— unit, wherein r is an integer from 1 to 4;
R is a hydroxyfunctional carbon acid ester unit of formula 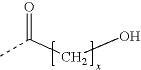
wherein x is an integer from 3 to 5; or
a CH(OH)Y group, wherein
Y is a —CH2—N(R2R3) group, wherein
R2 is H or a methyl, ethyl, n-propyl, iso-propyl, cyclohexyl, 2-hydroxyethyl, 2-hydroxypropyl or 3-hydroxypropyl radical; and
R3 is a 2-hydroxyethyl, 2-hydroxypropyl, or 3-hydroxypropyl radical;
R1 is, identically or differently, H or a C1 to C10 hydrocarbon radical optionally containing hetero atoms; and
n is an integer from 1 to 40; and
D) optionally, blocking agents;
to form a dispersion; and incorporating optionally surface-modified inorganic particles having an average particle size of less than 200 nm, as determined by means of dynamic light scattering in dispersion, into said dispersion.

2. The process of claim 1, wherein said polyisocyanate comprises a uretdione, isocyanurate, allophanate, biuret, iminooxadiazinedione, and/or oxadiazinetrione structure.

3. The process of claim 1, wherein said polyisocyanate is based on IPDI, MDI, TDI, HDI, or mixtures thereof.

4. The process of claim 1, wherein, in formula (I), X is an alkoxy or hydroxyl group, Y is a linear or branched C₁-C₄ alkyl group, Z is a linear or branched C₁-C₄ alkylene group, a is 1 or 2, and Q is a group which reacts with isocyanates to form urethane, urea, or thiourea moieties.

5. The process of claim 1, wherein said alkoxysilane of formula (I) is an alkoxysilyl-containing aspartic ester.

6. The process of claim 1, wherein X in formula (II) is —CH₂—, —CH₂CH₂—, —CH₂CH₂CH₂—, —CH(CH₃)CH₂—, —CH₂CH₂CH₂CH₂—, —CH₂CH₂CH(CH₃)—, or —CH₂CH(CH₃)CH₂—, wherein Z is H and n is an integer from 1 to 5 in said —[OCH₂—CHZ]ₙO— unit, wherein r is 3 in said CH₂O(CH₂)ᵣ— unit, and wherein x is 5.

7. The process of claim 6, wherein X in formula (II) is —CH₂—.

8. The process of claim 1, wherein said hydroxyl-containing polydimethylsiloxane of formula (II) has a number-average molecular weight of 250 to 2250 g/mol.

9. The process of claim 1, wherein the ratio of NCO groups of said polyisocyanate to the NCO-reactive OH groups of said hydroxyl-containing polysiloxane of formula (II) is in the range of from 1:0.001 to 1:0.4 and the ratio of NCO groups of said polyisocyanate to the NCO-reactive groups Q of said alkoxysilane of formula (I) is in the range of from 1:0.01 to 1:0.75.

10. The process of claim 1, wherein blocking agents are used in said process in amount that results in the blocking of any remaining free isocyanate groups.

11. The process of claim 1, wherein said inorganic particles having an average particle size of less than 200 nm comprise are incorporated in the form of a dispersion in an organic solvent.

12. The process of claim 11, wherein said organic solvent is alcohol-free and ketone-free.

13. The process of claim 1, wherein said inorganic particles having an average particle size of less than 200 nm comprise silicon oxide, aluminium oxide, cerium oxide, zirconium oxide, niobium oxide, titanium oxide, or zinc oxide.

14. The process of claim 1, wherein said inorganic particles having an average particle size of less than 200 nm are surface-modified.

15. A nanoparticle-modified polyisocyanate obtained by the process of claim 1.

16. A polyurethane system comprising the nanoparticle-modified polyisocyanate of claim 15.

17. A coating, adhesive bond, or moulding comprising the polyurethane system of claim 16.
